(19) United States
(12) Patent Application Publication
(10) Pub. No.: US 2024/0112000 A1
(43) Pub. Date: Apr. 4, 2024

(54) NEURAL GRAPHICAL MODELS

(71) Applicant: Microsoft Technology Licensing, LLC, Redmond, WA (US)

(72) Inventors: Harsh SHRIVASTAVA, Redmond, WA (US); Urszula Stefania CHAJEWSKA, Issaquah, WA (US)

(21) Appl. No.: 17/949,721

(22) Filed: Sep. 21, 2022

(51) Int. Cl. G06N 3/04; G06N 3/08

(52) U.S. Cl. CPC G06N 3/0472; G06N 3/08

(57) ABSTRACT

The present disclosure relates to methods and systems for providing a neural graphical model. The methods and systems generate a neural view of the neural graphical model for input data. The neural view of the neural graphical model represents the functions of the different features of the domain using a neural network. The functions are learned for the features of the domain using a dependency structure of an input graph for the input data using neural network training for the neural view. The methods and systems use the neural graphical model to perform inference tasks. The methods and systems also use the neural graphical model to perform sampling tasks.

### BACKGROUND

Graphs are ubiquitous and are often used to understand the dynamics of a system. Probabilistic Graphical Models (Bayesian and Markov networks), Structural Equation Models and Conditional Independence Graphs are some of the popular graph representation techniques that can model relationship between features (nodes) as a graph together with its underlying distribution or functions over the edges that capture dependence between the corresponding nodes. Often simplifying assumptions are made in probabilistic graphical models due to technical limitations associated with the different graph representations.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some implementations relate to a method. The method includes obtaining an input graph for a domain based on input data generated from the domain. The method includes identifying a dependency structure from the input graph. The method includes generating a neural view of a neural graphical model for the domain using the dependency structure.

Some implementations relate to a device. The device includes a processor; memory in electronic communication with the processor; and instructions stored in the memory, the instructions executable by the processor to: obtain an input graph for a domain based on input data generated from the domain; identify a dependency structure from the input graph; and generate a neural view of a neural graphical model for the domain using the dependency structure.

Some implementations relate to a method. The method involves training a neural graphical model. The method includes learning functions for the features of the domain. The method includes initializing weights and parameters of the neural network for a neural view. The method include optimizing the weights and the parameters of the neural network using a loss function. The method includes learning the functions using the weights and the parameters of the neural network based on paths of the features through hidden layers of the neural network from an input layer to an output layer.

Some implementations, relate to a device. The device includes a processor; memory in electronic communication with the processor; and instructions stored in the memory, the instructions executable by the processor to: train a neural graphical model; learn functions for the features of the domain; initialize weights and parameters of the neural network for a neural view; optimize the weights and the parameters of the neural network using a loss function; and learn the functions using the weights and the parameters of the neural network based on paths of the features through hidden layers of the neural network from an input layer to an output layer.

Some implementations relate to a method. The method includes receiving a query for a domain. The method includes accessing a neural view of a neural graphical model of the domain. The method includes using the neural graphical model to perform an inference task to provide an answer to the query. The method includes outputting a set of values for the neural graphical model based on the inference task for the answer.

Some implementations relate to a device. The device includes a processor; memory in electronic communication with the processor; and instructions stored in the memory, the instructions executable by the processor to: receive a query for a domain; access a neural view of a neural graphical model of the domain; use the neural graphical model to perform an inference task to provide an answer to the query; and output a set of values for the neural graphical model based on the inference task for the answer.

Some implementations relate to a method. The method includes accessing a neural view of a neural graphical model of a domain. The method includes using the neural graphical model to perform a sampling task. The method includes outputting a set of samples generated by the neural graphical model based on the sampling task.

Some implementations relate to a device. The device includes a processor; memory in electronic communication with the processor; and instructions stored in the memory, the instructions executable by the processor to: access a neural view of a neural graphical model of a domain; use the neural graphical model to perform a sampling task; and output a set of samples generated by the neural graphical model based on the sampling task.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for generating neural graphical models in accordance with implementations of the present disclosure.

FIG. 2 illustrates an example graphical view of a neural graphical model and an example dependency structure in accordance with implementations of the present disclosure.

FIG. 3 illustrates an example neural view of a neural graphical model in accordance with implementations of the present disclosure.

FIG. 4 illustrates an example method for generating a neural view of a neural graphical model in accordance with implementations of the present disclosure.

FIG. 5 illustrates an example method for performing an inference task using a neural view of a neural graphical model in accordance with implementations of the present disclosure.

FIG. 6 illustrates an example method for performing a sampling task using a neural view of a neural graphical model in accordance with implementations of the present disclosure.

FIG. 7 illustrates components that may be included within a computer system.

### DETAILED DESCRIPTION

This disclosure generally relates to graphs. Massive and poorly understood datasets are more and more common. Few tools exist for unrestricted domain exploration of the datasets. Most machine learning tools are oriented towards prediction: the machine learning tools select an outcome variable and input variables and only learn the impact of the latter on the former. Relationships between other variables in the dataset are ignored. Exploration can uncover data flaws and gaps that should be remedied before prediction tools can be useful. Exploration can also guide additional data collection. Graphs are an important tool to understand massive data in a compressed manner.

Moreover, graphical models are a powerful tool to analyze data. Graphical models can represent the relationship between the features of the data and provide underlying distributions that model the functional dependencies between the features of the data. Probabilistic graphical models (PGMs) are quite popular and often used to describe various systems from different domains. Bayesian networks (directed acyclic graphs) and Markov networks (undirected graphs) can represent many complex systems due to their generic mathematical formulation.

Conditional Independence (CI) graphs are a type of Probabilistic Graphical Models primarily used to gain insights about the feature correlations to help with decision making. The conditional independence graph represents the partial correlations between the features and the connections capture the features that are ‘directly’ correlated to one another. Formulations to recover such CI graphs from the input data include modeling using (1) linear regression, (2) recursive formulation, and (3) matrix inversion approaches. The CI graphs can be directed or undirected depending on the graph recovery algorithm used. However, representing the structure of the domain in the form of conditional independence graph is not sufficient.

One of the common bottleneck of traditional graphical model representations is having high computational complexities for learning, inference, and/or sampling. Learning consists of fitting the distribution function parameters. Inference is the procedure of answering queries in form of marginal distributions or reporting conditional distributions with one or more observed variables. Sampling is the ability to draw samples from the underlying distribution defined by the graphical model.

Traditional probabilistic graphical models only handle a restricted set of distributions. Traditional probabilistic graphical models place constraints on the type of distributions over the domain. An example of a constraint on a type of distribution is only allowing categorical variables. Another example of a constraint on a type of distribution is only allowing gaussian continuous variables. Another example is a restriction for directed graphs that there cannot be arrows pointing from continuous to categorical features. Another example of a constraint on a type of distribution is only dealing with continuous features. In addition, traditional probabilistic graphical models make assumptions to learn the parameters of the distribution. As such, traditional probabilistic graphical models fit a complex distribution into a restricted space, and thus, provide an approximation of a distribution over the domain.

The methods and systems of the present disclosure provide a framework for capturing a wider range of probability distributions over a domain. The domain includes different features related to different aspects of the domain with information for each feature. One example domain is a disease process domain with different features related to the disease process. Another example domain is a college admission domain with different features relating to a student's college admission (e.g., SAT scores, high school GPA, admission to a state university, and admission to an ivy league college).

The methods and systems of the present disclosure generate a neural graphical model that represents probabilistic distributions. The neural graphical model is a type of probabilistic graphical model that handles complex distributions over a domain and represents a richer set of distributions as compared to traditional probabilistic graphical models. The neural graphical models remove the restrictions previously placed over a domain by traditional probabilistic graphical models. For example, the neural graphical models remove the restriction placed by traditional probabilistic graphical models that all continuous variables are gaussian. As such, the neural graphical models of the present disclosure represent complex distributions without restrictions on the domains or predefined assumptions of the domains, and thus, may capture any type of distribution defined by the data for a domain.

In some implementations, the neural graphical models are presented in a graphical view that illustrates the different features of the domain and the connections between the different features. The graphical view provides a high level view of the conditional independence between the features (which features are conditionally independent of other features given remaining features) in the neural graphical models. In some implementations, the graphical view illustrates the connections between features using edges in a graph. The information in the graphical view is used to generate a dependency structure of the features that defines the relationship among the features of the domain. The dependency structure identifies the connections among the different features of the domain.

In some implementations, the neural graphical models are presented in a neural view with a neural network. The neural view of the neural graphical models represents the functions of the different features using a neural network. The neural network represents the distribution(s) over the domain. In some implementations, the neural network is a deep learning architecture with hidden layers. The functions represented using the neural view capture the dependencies identified in the dependency structure. The functions are represented in the neural view by the path from an input feature through the neural network layer(s) to the output feature. Thus, as the number of neural network layer increases in the neural view, the complexity of the functions represented by the neural view increases. The neural view of the neural graphical models represent complex distributions of features over a domain.

In some implementations, the methods and systems of the present disclosure use the neural view of the neural graphical models to learn the parameters of the functions of the features of a domain from the input data. The methods and systems of the present disclosure learn the distributions and the parameters of the distribution using the neural graphical models. The methods and systems of the present disclosure may leverage multiple graphic processing units (GPUs) as well as scale over multiple cores, resulting in fast and efficient algorithms. As such, the neural graphical models are learned from data efficiently as compared to some traditional probabilistic graphical models.

One technical advantage of the systems and methods of the present disclosure is facilitating rich representations of complex underlying distributions. Another technical advantage of the systems and methods of the present disclosure is supporting various relationship type graphs (e.g., directed, undirected, mixed-edge graphs). Another technical advantage of the systems and methods of the present disclosure is fast and efficient algorithms for learning, inference, and sampling.

The neural graphical model of the present disclosure represents complex distributions in a compact manner, and thus, represent complex feature dependencies with reasonable computational costs. The neural graphical models capture the dependency structure between features provided by an input graph along with the features' complex function representations by using neural networks as a multi-task learning framework. The methods and systems provide efficient learning, inference, and sampling algorithms for use with the neural graphical models. The neural graphical models can use generic graph structures including directed, undirected, and mixed-edge graphs, as well as support mixed input data types. The complex distributions represented by the neural graphical model may be used for downstream tasks, such as, inference, sampling, and/or prediction.

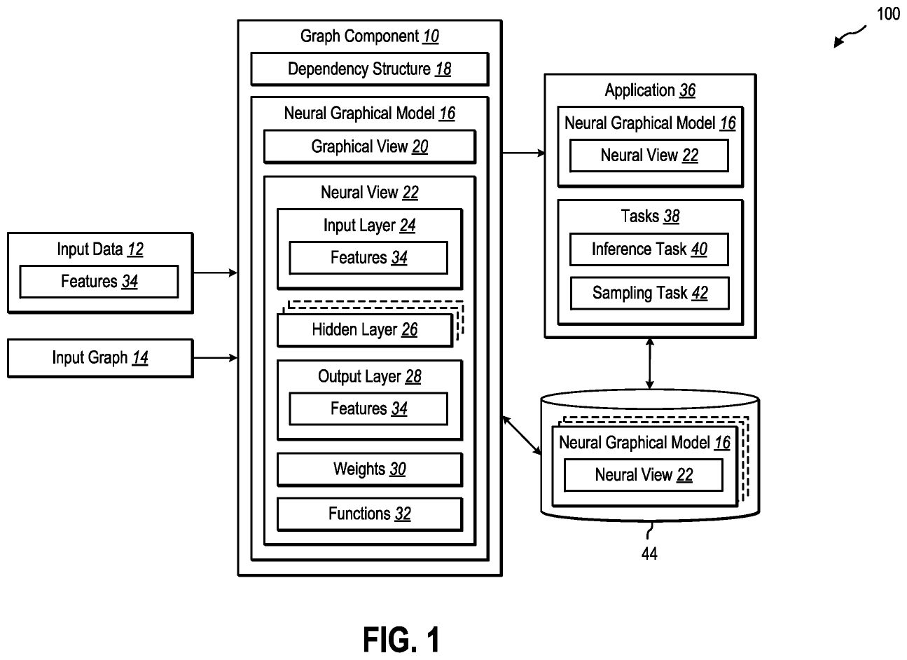

Referring now to FIG. 1, illustrated is an example environment 100 for generating neural graphical models 16. A neural graphical model 16 is a type of probabilistic graphical model implemented using a deep neural network that handles complex distributions over a domain. A domain is a complex system being modeled (e.g., a disease process or a school admission process). The neural graphical model 16 represents complex distributions over the domain without restrictions on the domain or predefined assumptions of the domain, and thus, may capture any type of data for the domain.

The environment 100 includes a graph component 10 that receives input data 12 for the domain. The input data 12 includes a set of samples taken from the domain with each sample containing a set of value assignments to the domain's features 34. One example domain is a college admission process and the features 34 include grades for the students, admission test scores for the students, extra circular activities for the students, and the schools that admitted the students. Another example domain is a health study relating to COVID and the features 34 include the age of the patients, the weight of the patients, pre-existing medical conditions of the patients, and whether the patients developed COVID. The input data 12 is the underlying data for an input graph 14.

The graph component 10 obtains the input graph 14. In some implementations, the graph component 10 receives the input graph 14 for the input data 12. The graph component 10 supports generic graph structures, including directed graphs, undirected graphs, and/or mixed-edge graphs. In some implementations, the input graph 14 is a directed graph with directed edges between the nodes of the graph. In some implementations, the input graph 14 is an undirected graph with undirected edges between nodes of the graph. In some implementations, the input graph 14 is a mixed edge type of graph with directed and undirected edges between the nodes of the graph.

In some implementations, the input graph 14 is generated by the graph component 10 using the input data 12. For example, the graph component 10 uses a graph recovery algorithm to generate the input graph 14 and determines the graph structure for the input graph 14 based on the input data 12.

The graph component 10 uses the input graph 14 to determine a dependency structure 18 from the input graph 14. The dependency structure 18 is the set of conditional independence assumptions encoded in the input graph 14. In some implementations, the dependency structure 18 is read directly from the input graph 14. In some implementations, the dependency structure 18 is represented as an adjacency matrix for undirected graphs. In some implementations, the dependency structure 18 is represented as the list of edges for Bayesian network graphs. The dependency structure 18 identifies which features 34 in the input data 12 are directly correlated to each other and which features 34 in the input data 12 exhibit conditional independencies.

The graph component 10 generates a neural graphical model 16 of the input graph 14 and the input data 12 using the dependency structure 18. The neural graphical model 16 may use generic graph structures including directed graphs, undirected graphs, and/or mixed-edge graphs.

In some implementations, the graph component 10 provides a graphical view 20 of the neural graphical model 16. The graphical view 20 specifies that the value of each feature 34 can be represented as a function of the value of its neighbors in the graph. The graphical view 20 may also illustrate correlated features 34 by edges between the correlated features 34.

Example equations the graph component 10 uses to determine the functions for each feature 34 in an undirected input graph 14 include:

xᵢ=fᵢ(Nbrs(xᵢ) (1)

where X∈R^{M×D}, R is a set of real numbers, X is the input data 12 that has M sample points with each consisting of D features 34 and each feature 34 (xᵢ) is a function of the neighboring features. An example equation the graph component 10 uses to determine the functions for each feature 34 in a directed input graph 14 includes:

xᵢ=fᵢ(MB(xᵢ)) (2)

where MB stands for the Markov blanket of a node in a directed acyclic graph. The dependency structure 18 represents the functions determined for the features 34. The graph component 10 uses the graphical view 20 of the neural graphical model 16 and the dependency structure 18 and the input data 12 to learn a neural view 22 of the neural graphical model 16. The neural view includes an input layer 24 with the features 34 of the input data 12. The neural view 22 also includes hidden layers 26 of a neural network. In some implementations, the neural network is a deep learning architecture with one or more layers. The neural networks are a multi-layer perceptron with appropriate input and output dimensions depending on the graph types (directed, undirected or mixed edge) that represents the graph connections in the neural graphical model 16. The number of hidden layers 26 in the neural view 22 may vary based on the number of the features 34 of the input data 12 and the complexity of the relationships between them. As such, any number of hidden layers 26 may be used in the neural view 22. In addition, any number of nodes in the hidden layers may be used. For example, the number of nodes in the hidden layers equals the number of input features 34. Another example includes the number of nodes in the hidden layers are less than the number of input features. Another example includes the number of nodes in the hidden layers exceed the number of input features. The number of input features 34, the number of hidden layers 26, and/or the number of nodes in the hidden layers 26 may change based on the input data 12 and/or the input graph 14.

The neural view 22 also includes an output layer 28 with features 34. The neural view includes weights 30 applied to each connection between the nodes in the input layer 24 and the nodes in the first hidden layer 26 and the nodes in each pair of consecutive hidden layers and connections between the last hidden layer 26 and the nodes in the output layer 28. The paths from the nodes in the input layer 24 to the nodes in the output layer 28 through the nodes in the hidden layer(s) 26 represent the functional dependencies of the features 34. The weights (network parameters) jointly specify the functions 32 between the features 34. An example equation the graph component 10 uses to discover the paths between a pair of nodes is to perform a matrix multiplication of the weights 30 is:

Sₙₙ=πᵢ|Wᵢ|=|W₁|×|W₂|× . . . ×|W_{C}| (3)

where W is the weights 30. If Sₙₙ[xᵢ, xₒ]=0, the output feature 34 (x₀) does not depend on the input feature 34 (xᵢ).

Increasing the number of hidden layers 26 and hidden dimensions of the neural networks, provides richer dependence function complexity for the functions 32. One example of a complex function 32 represented in the neural view 22 is an expression of the non-linear dependencies of the different features 34. A wide range of complex non-linear functions may be represented using the neural view 22. The neural view 22 of the neural graphical model 16 provides a rich functional representation of the features 34 of the input data 12 over the domain.

In some implementations, the graph component 10 performs a learning task to learn the neural view 22 of the neural graphical model 16. The learning task fits the neural networks to achieve the desired dependency structure 18, or an approximation to the desired dependency structure 18, along with fitting the regression to the input data 12. The learning task learns the functions as described by the graphical view 20 of the neural graphical model 16. The graph component 10 solves the multiple regression problems shown in the neural view 22 by modeling the neural view 22 as a multi-task learning framework. The graph component 10 finds a set of parameters {W} (the weights 30) that minimize the loss expressed as the distance from I^{k} to f_{W} (X_{I}^{k}) while maintaining the dependency structure 18 provided in the input graph 14.

One example equation the graph component 10 uses to define the regression operation is:

$$\\ \begin{matrix}{arg min}_{w} {\sum }_{k = 1}^{M} {‖ {X}_{ℐ}^{k} - fw ( {X}_{ℐ}^{k} ) ‖}^{2} & ( 4 )\end{matrix}$$

$$\\ s . t . ( {\prod }_{i} \vert {W}_{i} \vert ) * {S}^{c} = 0$$

where S^{c} represents the compliment of the matrix S, which replaces 0 by 1 and vice-versa. The A*B represents the hadamard operator which does an element-wise matrix multiplication between the same dimension matrices A, B, where A and B are any arbitrary matrices.

Including the constraint as a lagrangian term with [symbol] ₁ penalty and a constant λ that acts a tradeoff between fitting the regression and matching the input graph 14 dependency structure 18, in some implementations, the graph component 10 uses the following optimization formulation:

$$\\ \begin{matrix}{arg min}_{w} {\sum }_{k = 1}^{M} {‖ {X}_{ℐ}^{k} - fw ( {X}_{ℐ}^{k} ) ‖}^{2} + λ {‖ ( {\prod }_{i} \vert {W}_{i} \vert ) * {S}^{c} ‖}_{1} & ( 5 )\end{matrix}$$

where the bias term is not explicitly written in the optimization formulation, the graph component 10 learns the weights 30 {Wᵢ} and the biases {bᵢ} while optimizing the optimization formulation (6). In some implementations, the individual weights 30 are normalized using [symbol] ₂-norm before taking the product. The regression loss and the structure loss term are normalized separately, so that both the losses are on a similar scale while training and recommend the range of λ=[1e-2, 1e2]. Appropriate scaling is applied to the input data 12 features 34 throughout.

In some implementations, the graph component 10 finds an initialization for the neural network parameters W (the weights 30) and λ by solving the regression operation without the structure constraints. Solving the regression operation without the structure constraints provides a good initial guess of the neural network weights 30 (W⁰) for the graph component 10 to use in the learning task. The graph component 10 looks at the values of undesired paths in the initial weight guess to determine how distant this initial approximation is from the structure constraints. In some implementations, the graph component 10 uses the following equation for choosing the value of λ:

λ=∥(πᵢ|Wᵢ⁰|)*S^{c}∥₂² (6)

and updates after each epoch. In some implementations, the graph component 10 chooses a fixed value of λ such that it balances between the regression loss and the structure loss for the optimization.

In some implementations, the graph component 10 uses following learning algorithm to perform the learning task and learn the neural view 22 of the neural graphical model 16.

Algorithm 1: Learning Algorithm

Function proximal-init (X, S):
| [symbol] ← Init MLP using dimensions from S
| [symbol] ⁰ ← arg min_{W} Σ [symbol] ^{M} ||X [symbol] ^{k} − [symbol] (X [symbol] )||²
| (Using ‘adam’ optimizer for E₁ epochs)
|_return [symbol] ⁰
Function fit-NGM(X, S, [symbol] ⁰, λ⁰):
| For e = 1 ... , E₂ do
| | [symbol] [symbol] = Σ [symbol] ^{M} ||X [symbol] ^{k} − [symbol] [symbol] (X [symbol] )||²
| | +X [symbol] ||(II [symbol] |W [symbol] |) [symbol] S [symbol] ||₁
| | [symbol] ← backprop [symbol] [symbol] to update params
| | ... (optional λ update) ...
| | X [symbol] ← ||(II [symbol] |W [symbol] |) [symbol] S [symbol] ||₂²
| |_ Detach λ [symbol] from the computational graph
|_return Θ, Z, λ
Function NGM-learning(X, S):
| [symbol] ⁰ ← proximal-init(X, S)
| λ⁰ ← ||(II [symbol] |W [symbol] ⁰|) [symbol] S [symbol] ||₂²
| [symbol] ←fit-NGM (X,S, [symbol] ⁰,λ⁰)
|_return [symbol] [symbol]
indicates data missing or illegible when filed

The neural network trained using the learning algorithm represents the distributions for the neural view 22 of the neural graphical model 16. One benefit of jointly optimizing the regression and the structure loss in a in a multi-task learning framework modeled by the neural view 22 of the neural graphical model 16 includes sharing of parameters across tasks, resulting in significantly reducing the number of learning parameters. Another benefit of jointly optimizing the regression and the structure loss in a in a multi-task learning framework modeled by the neural view 22 of the neural graphical model 16 includes making the regression task more robust towards noisy and anomalous data points.

Another benefit of the neural view 22 of the neural graphical model 16 includes fully leveraging the expressive power of the neural networks to model complex non-linear dependencies. Additionally, learning all the functional dependencies jointly allows leveraging batch learning powered with GPU based scaling to get quicker runtimes. Another benefit of the neural view 22 of the neural graphical model 16 includes accessing individual dependency functions between the variables for more fine grained analysis.

The graph component 10 outputs the neural graphical model 16 and/or the neural view 22. In some implementations, the graph component 10 provides the neural graphical model 16 and/or the neural view 22 for storage in a datastore 44.

In some implementations, the graph component 10 provides the neural graphical model 16 and/or the neural view 22 to one or more applications 36 that perform one or more tasks 38 on the neural graphical model 16. The applications 36 may be accessed using a computing device. For example, a user of the environment 100 may use a computing device to access the applications 36 to perform one or more tasks 38 on the neural graphical models 16. In some implementations, the applications 36 are remote from the computing device. In some implementations, the applications 36 are local to the computing device.

One example task 38 includes prediction using the neural graphical model 16. Another example task 38 includes an inference task 40 using the neural graphical model 16. Inference is the process of using the neural graphical model 16 to answer queries. For example, a user provides a query to the application 36 and the application 36 uses the graphical model 16 to perform the inference task 40 on the neural graphical model 16 and output an answer to the query.

Calculation of marginal distributions and conditional distributions are key operations for the inference task 40. Since the neural graphical models 16 are discriminative models, for the prior distributions, the marginal distributions are directly calculated from the input data 12.

One example query is a conditional query. The inference task 40 is given a value of a node Xᵢ (one of feature 34) of the neural graphical model 16 and predicts the most likely values of the other nodes (features) in the neural graphical model 16. In some implementations, the application 36 uses iterative procedures to answer conditional distribution queries over the neural graphical model 16 using the inference algorithm to perform the inference task 40.

Algorithm 2: Inference Algorithm

Function gradient-based( [symbol] , X [symbol] ):
| {Xₖ, Xᵤ} ← X [symbol] split the data
| Xₖ ← fixed tensor (known)
| Xᵤ ← learnable tensor (unknown)
| [symbol] ← freeze weights
| do
| | X₁ ← {Xₖ, Xᵤ}
| | X_{P} = [symbol] (X₁)
| | [symbol] _{In} = ||Xₚ[k] − X₁[k]||₂²
| | Xᵤ ← updated by backprop on [symbol] _{In}
| while [symbol] _{In} > [symbol]
|_ return X [symbol]
Function message-passing( [symbol] , X⁰):
| X_{K} + X_{U}⁰ ← X⁰, split the data
| t = 0
| while ||X^{t} − X^{t-1}||₂² > [symbol] do
| | {X [symbol] Xₖ} = [symbol] ({X [symbol] Xₖ})
| |_ t = t + 1
| X^{t} ← X_{K} + X_{U}^{t}
|_ return X^{t}
Function NGM-inference( [symbol] , X⁰):
| Input: [symbol] trained NGM model
| X⁰ ∈ [symbol] ^{D×1} (mean values for unknown)
| X ←message-passing ( [symbol] , X⁰)
| ... or ...
| X ←gradient-based ( [symbol] , X⁰)
|_ return X [symbol]
indicates data missing or illegible when filed

The application 36 splits the input data 12 (X) into two parts Xₖ+X_{U}←X, where k denotes the known (observed) variable values and u denotes the unknown (target) variables. The inference task 40 is to predict the values and/or distributions of the unknown nodes based on the trained neural graphical model 16 distributions.

In some implementations, the application 36 uses the message passing algorithm, as illustrated in the inference algorithm, for the neural graphical model 16 in performing the inference task 40. The message passing algorithm keeps the observed values of the features fixed and iteratively updates the values of the unknowns until convergence. The convergence is defined as the distance (dependent on data type) between current feature prediction and the value in the previous iteration of the message passing algorithm. The values are updated by passing the newly predicted feature values through the neural view 22 of the neural graphical model 16.

In some implementations, the application 36 uses the gradient-based algorithm, as illustrated in the inference algorithm, for the neural graphical model 16 in performing the inference task 40. The weights 30 of the neural view 22 of the trained neural graphical model 16 are frozen once trained. The input data 12 (X) is divided into fixed Xₖ (observed) and learnable Xᵤ (target) tensors. A regression loss is defined over the known attribute values to ensure that the prediction matches values for the observed features. Using the regression loss, the learnable input tensors are updated until convergence to obtain the values of the target features.

Since the neural view 22 of the neural graphical model 16 is trained to match the output layer 28 to the input layer 24 the procedure of iteratively updating the unknown features such that the input and output matches. The regression loss is grounded based on the observed feature values. Based on the convergence loss value reached after the optimization, the confidence in the inference task 40 may be assessed. Furthermore, plotting the individual feature dependency functions also help in gaining insights about the predicted values. The neural view 22 also allows the inference task 40 to move forward or backwards through the neural network to provide an answer to the query.

Another example task 38 includes a sampling task 42 using the neural graphical model 16. Sampling is the process to get sample data points from the neural graphical model 16. One example use case of sampling includes accessing a trained neural view 22 for a neural graphical model 16 for patients with COVID. The sampling task 42 generates new patients jointly matching the distribution of the original input data.

In some implementations, a user uses a computing device to access the application 36 to perform the sampling task 42 using the neural graphical model 16. In some implementations, the application 36 uses a sampling algorithm to perform the sampling task 42 over the neural graphical model 16.

Algorithm 3: Sampling Algorithm
Algorithm 3: NGMs: Sampling algorithm

Function get-sample( [symbol] ):
| D = len( [symbol] )
| X ∈ [symbol] ^{D×1} (random init, learnable tensor)
| For i = [symbol] , ... , D do
| | X[i] = X[i] + [symbol] (add random noise)
| | X [symbol] ← X [1 : i] (fixed tensor)
| | Xᵤ ← X [i + 1 : D] (learnable tensor)
| | X ← {Xₖ, Xᵤ}
| |_ X ← NGM-inference( [symbol] , X)
|_ return X
Function NGM-sampling( [symbol] , G):
| Input: [symbol] learned NGM model
| Randomly [symbol] th feature
| D [symbol] =BFS(G, [symbol] ) [undirected]
| ... queue the features ...
| D [symbol] =topological-sort(G) [DAGs]
| X ←get-sample ( [symbol] , D [symbol] )
|_ return X [symbol]
indicates data missing or illegible when filed

The sampling task 42 for the neural graphical models 16 based on undirected input graphs 14 uses the following equation:

Xᵢ=fₙₙ(nbrs(Xᵢ))+ϵ (7)

where ϵ˜P is random noise. The sampling task 42 for the neural graphical models 16 based on directed input graphs 14 uses the equation (8) with Pa(Xᵢ) instead of nbrs(Xᵢ).

The sampling task 42 starts by choosing a feature at random in the neural graphical model 16 and based on the dependency structure 18 of the neural graphical model 16. In some implementations, the input graph 14 that the neural graphical model 16 is based on is an undirected graph and a breadth-first-search is performed to get the order in which the features will be sampled and the nodes are arranged in Dₛ. In some implementations, the input graph 14 that the neural graphical model 16 is based on is a directed graph and a topological sort is performed to get the order in which the features will be sampled, and the nodes are arranged in Dₛ. In this way, the immediate neighbors are chosen first and then the sampling spreads over the neural graphical model 16 away from the starting feature. As the sampling procedure goes through the ordered features, a slight random noise is added to the corresponding feature while keeping the noise fixed for the subsequent iterations (feature is now observed).

The sampling task 42 calls the inference algorithm conditioned on these fixed features to get the value of the next feature. The process is repeated until a sample value of all the features is obtained. The new sample of the neural graphical model 16 is not derived from the previous sample, avoiding the ‘burn-in’ period issue with traditional sampling tasks (e.g., Gibbs sampling) where initial set of samples are ignored. The conditional updates for the neural graphical models 16 are of the form p(Xᵢ^{k}, Xᵢ₊₁ [symbol] , . . . , X_{D}^{k}|X₁^{k}, . . . , Xᵢ₋₁^{k}). The sampling task 42 fixes the value of features (with a small added noise) and run inference on the remaining features until obtaining the values of all the features, and thus, obtain a new sample. The inference algorithm of the neural graphical model 16 facilitates conditional inference on multiple unknown features over multiple observed features. By leveraging the inference algorithm of the neural graphical model 16, faster sampling from the neural graphical model 16 is achieved.

In some implementations, one or more computing devices (e.g., servers and/or devices) are used to perform the processing of the environment 100. The one or more computing devices may include, but are not limited to, server devices, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the graph component 10 and the application 36 are implemented wholly on the same computing device. Another example includes one or more subcomponents of the graph component 10 and/or the application 36 are implemented across multiple computing devices. Moreover, in some implementations, one or more subcomponent of the graph component 10 and/or the application 36 may be implemented are processed on different server devices of the same or different cloud computing networks.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

The environment 100 is used to generate neural graphical models 16 that represent complex feature dependencies with reasonable computational costs. The neural graphical models 16 capture the dependency structure 18 between the features 34 of the input data 12 along with the complex function representations by using neural networks as a multi-task learning framework. The environment 100 provides efficient learning, inference, and sampling algorithms for use with the neural graphical models 16. In addition, the environment 100 uses the complex distributions represented by the neural graphical models 16 for downstream tasks, such as, an inference task 40, a sampling task 42, and/or a prediction task.

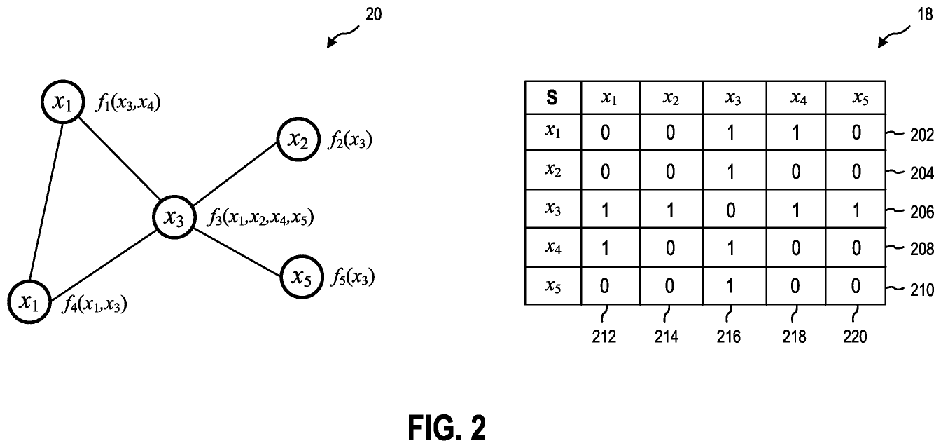

Referring now to FIG. 2, illustrated is a graphical view 20 of a neural graphical model 16. The graph component 10 (FIG. 1) generates the graphical view 20 of the neural graphical model 16 (FIG. 1) using the input data 12 (FIG. 1) and the input graph 14 (FIG. 1). The input graph 14 in this example is an undirected graph and the input data 12 includes five features (x₁, x₂, x₃, x₄, x₅) with information for each feature.

The graphical view 20 illustrates the connections between the different features (x₁, x₂, x₃, x₄, x₅) with an edge between the features that have connections to one another. In addition, the graphical view 20 illustrates the function of the different features (x₁, x₂, x₃, x₄, x₅). The graphical view 20 illustrates that the feature (x₁) is connected to the feature (x₃) and the feature (x₄). As such, the feature (x₁) is a function of the feature (x₃) and the feature (x₄), as illustrated by the function (f₁(x_{3,} x₄)).

The graphical view 20 also illustrates that the feature (x₂) is connected to the feature (x₃). Thus, the feature (x₂) is a function of the feature (x₁), as illustrated by the function (f₂(x₃)). The graphical view 20 also illustrates that the feature (x₃) is connected to the features (x₁, x₂, x₄, and x₅). As such, the feature (x₃) is a function of the features (x₁, x₂, x₄, and x₅), as illustrated by the function (f₃(x₁, x₂, x₄, x₅)).

In addition, the graphical view 20 illustrates that the feature (x₄) is connected to the feature (x₁) and the feature (x₃), and thus, is a function of the features (x_{1,} x₃), as illustrated by the function f₁(x_{1,} x₃). The graphical view 20 also illustrates that the feature (x₅) is connected to the feature (x₃). As such, the feature (x₅) is a function of the feature (x₃), as illustrated by the function (f₂(x₃)).

In some implementations, the graph component 10 generates a dependency structure 18 to illustrate where the connections are among the different features (x₁, x₂, x₃, x₄, x₅). In some implementations, the dependency structure 18 is a matrix with the features listed across the columns and down the rows of the matrix with a “1” indicating a connection among different features and a “0” indicating no connection. As such, the different rows and/or columns of the matrix are used to identify connections for the different features.

The row 202 of the matrix illustrates the connections for the feature (x₁) with a “1” in the column 216 of the feature (x₃) and a “1” in the column 218 of the feature (x₄). The row 204 of the matrix illustrates the connection for the feature (x₂) with a “1” in the column 216 of the feature (x₃). The row 206 illustrates the connections for the feature (x₃) with a “1” in the column 212 of the feature (x₁), a “1” in the column 214 of the feature (x₂), a “1” in the column 218 of the feature (x₄), and a “1” in the column 220 of the feature (x₅). The row 208 illustrates the connections for the features (x₄) with a “1” in the column 212 of the feature (x₁) and a “1” in the column 216 of the feature (x₃). The row 210 illustrates the connections for the feature (x₅) with a “1” in the column 216 of the feature (x₃).

The column 212 of the matrix illustrates the connections for the feature (x₁) with a “1” in the row 206 of the feature (x₃) and a “1” in the row 208 of the feature (x₄). The column 214 of the matrix illustrates the connection for the feature (x₂) with a “1” in the row 206 of the feature (x₃). The column 216 illustrates the connections for the feature (x₃) with a “1” in the row 202 of the feature (x₁), a “1” in the row 204 of the feature (x₂), a “1” in the row 208 of the feature (x₄), and a “1” in the row 210 of the feature (x₅). The column 218 illustrates the connections for the features (x₄) with a “1” in the row 202 of the feature (x₁) and a “1” in the row 206 of the feature (x₃). The column 220 illustrates the connections for the feature (x₅) with a “1” in the row 206 of the feature (x₃).

As such, the dependency structure 18 may be used to identify which features in the domain are directly correlated to each other (e.g., the “1” in the matrix) and which features in the domain exhibit conditional independencies (e.g., the “0” in the matrix).

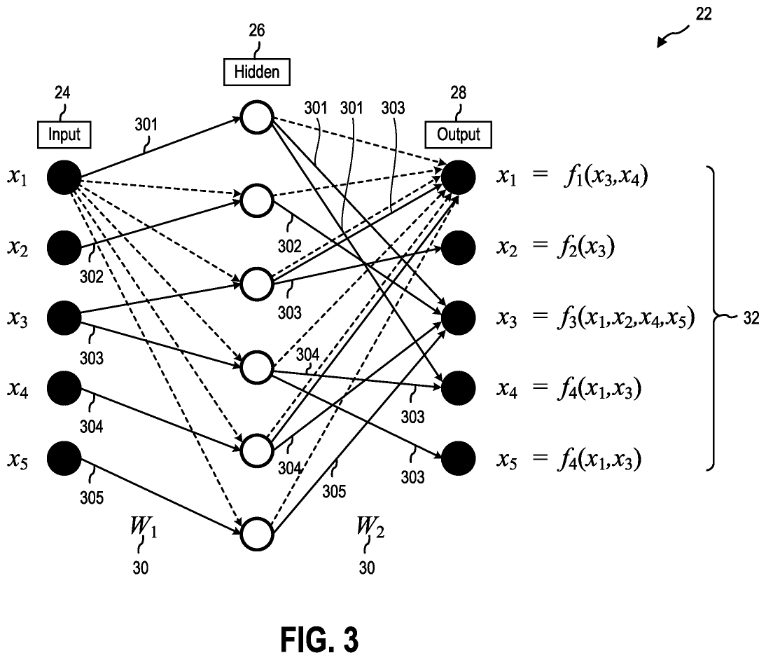

Referring now to FIG. 3, illustrated is an example neural view 22 of the graphical view 20 (FIG. 2) of the neural graphical model 16. The graph component 10 (FIG. 1) generates the neural view 22 by learning a set of parameters for the neural view 22. The neural view 22 includes an input layer 24 with a plurality of features (the five features (x₁, x₂, x₃, x₄, x₅)). The neural view 22 also includes hidden layers 26 of the neural network. The neural view 22 also includes an output layer 28 with a plurality of features (x₁, x₂, x₃, x₄, x₅) and the associated functions 32 (the functions f₁, f₂, f₃, f₄, f₅) for the features (x₁, x₂, x₃, x₄, x₅) computed using the entire neural network of the neural view 22. The neural view 22 also includes a plurality of weights 30 calculated (the weights W₁ and W₂) that are applied to the input features as the features are input into the hidden layer 26 of the neural network and output from the hidden layer 26 of the neural network. By applying the weights 30 to the features, the functions 32 generated are more complex and expressive. Thus, by adding layers to the hidden layers 26 and increasing the weights 30, the expressiveness and complexity of the functions 32 generated increases.

In the neural view 22, a path from the input feature to an output feature indicates a dependency between the input feature and the output feature. The dependency matrix between the input and output of the neural network reduces to a matrix multiplication operation Snn=πi|Wi|=|W1|×|W2|, which represents the product of the neural network weights that are normalized. For directed graphs, the directed graphs are first converted to an undirected graph by following a process called moralization. Moralizing the directed graphs facilitates downstream analysis of the directed graphs. After obtaining the moral graph, the dependency structure 18 may be modeled in the neural view 22 using a multi-layer perceptron that maps all features from the input layer 24 to the output layer 28.

The paths 301 through the hidden layer 26 of the neural network illustrate the connections of the feature (x₁) to the feature (x₃) and the feature (x₄). The path 302 through the hidden layer 26 of the neural network illustrates the connection of the feature (x₂) to the feature (x₃). The paths 304 through the hidden layer 26 of the neural network illustrate the connections of the feature (x₃) to the features (x₁), (x₂), (x₄), and (x₅). The paths 304 through the hidden layer 26 of the neural network illustrate the connections of the feature (x₄) to the feature (x₁) and the feature (x₃). The path 305 through the hidden layer 26 of the neural network illustrates the connection of the feature (x₅) to the feature (x₃). The functions 32 (f₁, f₂, f₃, f₄, f₅) illustrated are based on the paths 301, 302, 303, and 304 through the neural networks. The functions 32 (f₁, f₂, f₃, f₄, f₅) provided by the neural view 22 provide a rich functional representation of the dependencies of the features (x₁, x₂, x₃, x₄, x₅).

As such, the neural view 22 facilitates rich representations of complex underlying distributions of the domain. While only one hidden layer 26 is shown in FIG. 3, any number of hidden layers 26 and/or any number of nodes in each hidden layer may be added to the neural view 22. As the number of hidden layers 26 increase, the complexity of the functions 32 increases.

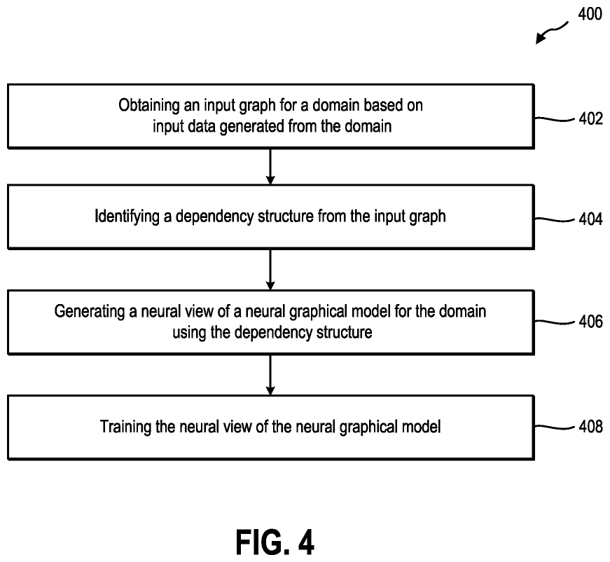

Referring now to FIG. 4, illustrated is an example method 400 for generating a neural view of a neural graphical model. The actions of the method 400 are discussed below with reference to the architectures of FIGS. 1-3.

At 402, the method 400 includes obtaining an input graph for a domain based on input data generated from the domain. The graph component 10 obtains the input graph 14 for the input 12. The input data 12 includes a plurality of data points for the domain with information for the features 34. The graph component 10 supports generic graph structures, including directed graphs, undirected graphs, and/or mixed-edge graphs. In some implementations, the input graph 14 is a directed graph with directed edges between the nodes of the graph. In some implementations, the input graph 14 is an undirected graph with undirected edges between nodes of the graph. In some implementations, the input graph 14 is a mixed edge type of graph with directed and undirected edges between the nodes of the graph. In some implementations, the input graph 14 is generated by the graph component 10 using the input data 12. For example, the graph component 10 uses a graph recovery algorithm to generate the input graph 14.

At 404, the method 400 includes identifying a dependency structure from the input graph. The graph component 10 uses the input graph 14 to determine a dependency structure 18 from the input graph 14. The dependency structure 18 identifies features 34 in the input data 12 that are directly correlated to one another and the features 34 in the input data 12 that are conditionally independent from one another.

At 406, the method 400 includes generating a neural view of a neural graphical model for the domain using the dependency structure. The graph component 10 generates the neural view 22 of the neural graphical model 16 for the input data 12 using the dependency structure 18. The neural graphical model 16 is a probabilistic graphical model over the domain. The neural graphical model 16 uses a directed input graph 14, an undirected input graph 14, or a mixed-edge input graph 14.

In some implementations, the graph component 10 provides a graphical view 20 of the neural graphical model 16. The graphical view 20 specifies that the value of each feature 34 can be represented as a function of the value of neighbors in the graph. For example, the graphical view 20 illustrates correlated features 34 by edges between the features (e.g., the correlated features 34 to one another have an edge connecting the features 34 to one another).

In some implementations, the graph component 10 provides a neural view 22 of the neural graphical model 16. The neural view 22 includes an input layer 24 with features 34 of the input data 12, hidden layers 26 of a neural network, weights 30, an output layer 28 with the features 34, and functions 32 of the features 34.

At 408, the method 400 includes training the neural view of the neural graphical model. The graph component 10 trains the neural view 22 of the neural graphical model 16 using the input data 12. The graph component 10 learns the functions 32 for the features 34 of the domain during the training of the neural view 22 of the neural graphical model 16. The functions 32 represent complex distributions over the domain. A complexity of the functions 32 is based on paths of the features 34 through the hidden layers 26 of the neural network from the input layer 24 to the output layer 28 and the different weights 30 of the neural network. The neural network trained during the training of the neural view 22 represents the distribution for the neural view 22 of the neural graphical model 16.

In some implementations, the graph component 10 performs a learning task to learn the functions 32 of the neural view 22 using the input data 12. In some implementations, the graph component 10 uses a learning algorithm (Algorithm 1: Learning Algorithm) to perform the learning task and learn the neural view 22 of the neural graphical model 16. The graph component 10 initializes the weights 30 and the parameters of the neural network for the neural view 22. The graph component 10 optimizes the weights 30 and the parameters of the neural network using a loss function. The loss function fits the neural network to the dependency structure 18 along with fitting a regression of the input data 12. The graph component 10 learns the functions 32 using the weights 30 and the parameters of the neural network based on paths of the features through hidden layers of the neural network from an input layer to an output layer. The graph component 10 updates the paths of the features 34 through the hidden layers 26 of the neural network from the input layer 24 to the output layer 28 based on the functions 32 learned. As such, the graph component 10 models the neural view 22 as a multi-task learning framework that finds a set of weights that minimize the loss while maintaining the dependency structure 18 provided in the input graph 14.

In some implementations, the graph component 10 provides the neural view 22 of the neural graphical model 16 as output on a display of a computing device. In some implementations, the graph component 10 provides the neural view 22 of the neural graphical model 16 for storage in a datastore 44.

As such, the method 400 is used to learn complex functions 32 of the input data 12. The neural view 22 facilitates rich representations of complex underlying distributions in the input data 12 using neural networks. Different sources or applications may use the representation of the neural view 22 to perform various tasks.

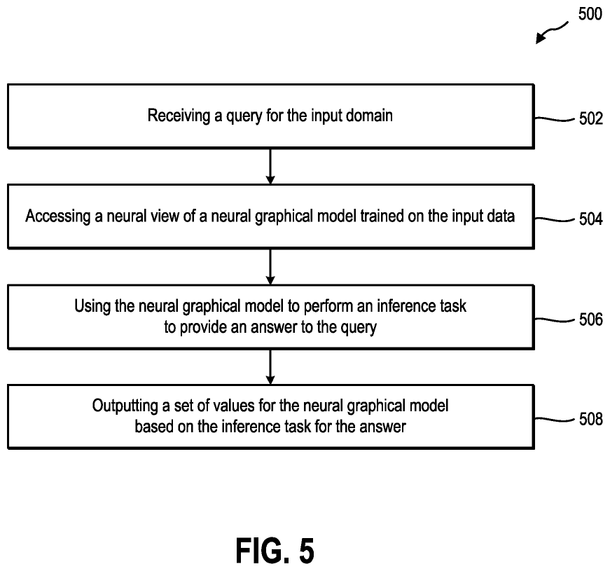

Referring now to FIG. 5, illustrated is an example method 500 for performing an inference task using a neural view of a neural graphical model. The actions of the method 500 are discussed below with reference to the architectures of FIGS. 1-3.

At 502, the method 500 includes receiving a query for a domain. A user, or other application, provides a query to the application 36. One example query is a conditional distribution query.

At 504, the method 500 includes accessing a neural view of a neural graphical model trained on the input data. The application 36 accesses a trained neural graphical model 16 of the domain associated with the query. The trained neural graphical model 16 provides insights into the domain from which the input data 12 was generated and which variables within the domain are correlated. In some implementations, the graph component 10 provides the neural graphical model 16 and/or the neural view 22 to the application 36. In some implementations, the application 36 accesses the neural graphical model 16 from a datastore 44.

At 506, the method 500 includes using the neural graphical model to perform an inference task to provide an answer to the query. The application 36 uses the neural graphical model 16 to perform an inference task 40 to answer queries. The inference task 40 splits the features 34 (X) into two parts Xₖ+X_{U}←X, where k denotes the known (observed) variable values and u denotes the unknown (target) variables. The inference task 40 is to predict the values of the unknown nodes based on the trained neural graphical model 16 distributions. The inference task 40 accepts a value of one or more nodes (features 34) of the neural graphical model 16 and predicts the most likely values of the other nodes in the neural graphical model 16. The neural view 22 also allows the inference task 40 to move forward or backwards through the neural network to provide an answer to the query. In some implementations, the application 36 uses iterative procedures to answer conditional distribution queries over the neural graphical model 16 using the inference algorithm (Algorithm 2: Inference Algorithm) to perform the inference task 40.

In some implementations, the inference task 40 uses the message passing algorithm, as illustrated in the inference algorithm (Algorithm 2: Inference Algorithm), for the neural graphical model 16 in performing the inference task 40. The message passing algorithm keeps the observed values of the features fixed and iteratively updates the values of the unknowns until convergence. The convergence is defined as the distance (dependent on data type) between current feature prediction and the value in the previous iteration of the message passing algorithm. The values are updated by passing the newly predicted feature values through the neural view 22 of the neural graphical model 16.

In some implementations, the inference task 40 uses the gradient-based algorithm, as illustrated in the inference algorithm (Algorithm 2: Inference Algorithm), for the neural graphical model 16 in performing the inference task 40. The weights 30 of the neural view 22 of the trained neural graphical model 16 are frozen once trained. The set of features 34 (X) is divided into fixed Xₖ (observed) and learnable Xᵤ (target) tensors. A regression loss is defined over the known attribute values to ensure that the prediction matches values for the observed features. Using the regression loss, the learnable input tensors are updated until convergence to obtain the values of the target features.

At 508, the method 500 includes outputting a set of values for the neural graphical model based on the inference task for the answer. The application 36 outputs the set of values for the neural graphical model 16 based on the inference task 40 for the answer to the query. In some implementations, the set of values are a fixed value. In some implementations, the set of values is a distribution over values. In some implementations, the set of values is both fixed values and a distribution overvalues.

The neural graphical model 16 provides direct access to the learned underlying distributions over the features 34 for analysis in the inference task 40. As such, the method 500 uses the neural graphical model 16 to perform fast and efficient inference tasks 40.

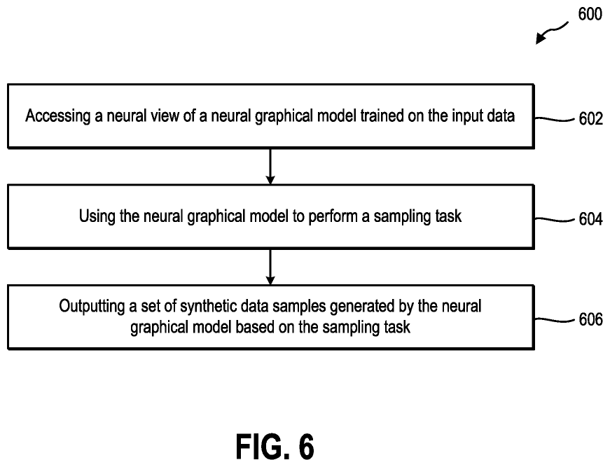

Referring now to FIG. 6, illustrated is an example method 600 for performing a sampling task using a neural view of a neural graphical model. The actions of the method 600 are discussed below with reference to the architectures of FIGS. 1-3.

At 602, the method 600 includes accessing a neural view of a neural graphical model trained on the input data. The application 36 accesses a neural view 22 of a trained neural graphical model 16 of the domain. The trained neural graphical model 16 provides insights into the domain and which variables within the domain are correlated. In some implementations, the graph component 10 provides the neural graphical model 16 and/or the neural view 22 to the application 36. In some implementations, the application 36 accesses the neural graphical model 16 from a datastore 44.

At 604, the method 600 includes using the neural graphical model to perform a sampling task. In some implementations, a user uses a computing device to access the application 36 to perform the sampling task 42 using the neural graphical model 16. In some implementations, the application 36 uses a sampling algorithm (Algorithm 3: Sampling Algorithm) to perform the sampling task 42 over the neural graphical model 16. Sampling is the process to get sample points from the neural graphical model 16.

The sampling task 42 starts by choosing a feature at random in the neural graphical model 16 and based on the dependency structure 18 of the neural graphical model 16. In some implementations, the input graph 14 that the neural graphical model 16 is based on is an undirected graph and a breadth-first-search is performed to get the order in which the features will be sampled and the nodes are arranged in Dₛ. In some implementations, the input graph 14 that the neural graphical model 16 is based on is a directed graph and a topological sort is performed to get the order in which the features will be sampled, and the nodes are arranged in Dₛ. In this way, the immediate neighbors are chosen first and then the sampling spreads over the neural graphical model 16 away from the starting feature. As the sampling procedure goes through the ordered features, a random noise is added to the corresponding feature value while keeping the value fixed for the subsequent iterations (feature is now observed).

The sampling task 42 calls the inference algorithm conditioned on these fixed features to get the values of the unknown features. The process is repeated until a sample value of all the features is obtained. The new sample of the neural graphical model 16 is not derived from the previous sample, avoiding the ‘burn-in’ period issue with traditional sampling tasks (e.g., Gibbs sampling) where initial set of samples are ignored. The conditional updates for the neural graphical models 16 are of the form p(Xᵢ^{k}, Xᵢ₊₁ [symbol] , . . . , X_{D}^{k}|X₁^{k}, . . . , Xᵢ₋₁^{k}). The sampling task 42 fixes the value of features (with a small added noise) and runs inference on the remaining features until obtaining the values of all the features, and thus, obtain a new sample. The inference algorithm of the neural graphical model 16 facilitates conditional inference on multiple unknown features over multiple observed features. By leveraging the inference algorithm of the neural graphical model 16, faster sampling from the neural graphical model 16 is achieved.

As such, the sampling task 42 randomly selects a node in the neural graphical model 16 as a starting node, places the remaining nodes in the neural graphical model in an order relative to the starting node, and creates a value for each node of the remaining nodes in the neural graphical model 16 based on values from neighboring nodes to each node of the remaining nodes. Random noise may be added to the values obtained by sampling from a distribution conditioned on the neighboring nodes.

At 606, the method 600 includes outputting a set of synthetic data samples generated by the neural graphical model based on the sampling task. The application 36 outputs a set of synthetic samples generated by the neural graphical model 16 based on the sampling task 42. The set of samples includes values for each features in features 34 in each sample generated from the neural graphical model 16.

The method 600 may be used to create values for the nodes from a same distribution over the domain from which the input data was generated. In addition, the method 600 may be used to create values for the nodes from conditional distributions of the neural graphical model conditioned on a given evidence.

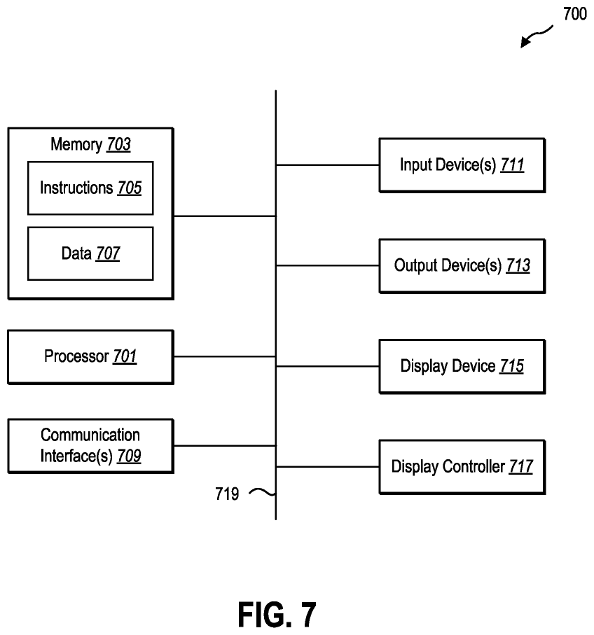

FIG. 7 illustrates components that may be included within a computer system 700. One or more computer systems 700 may be used to implement the various methods, devices, components, and/or systems described herein.

The computer system 700 includes a processor 701. The processor 701 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 701 may be referred to as a central processing unit (CPU). Although just a single processor 701 is shown in the computer system 700 of FIG. 7, in an alternative configuration, a combination of processors (e.g., an ARM and DSP) could be used.

The computer system 700 also includes memory 703 in electronic communication with the processor 701. The memory 703 may be any electronic component capable of storing electronic information. For example, the memory 703 may be embodied as random access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Instructions 705 and data 707 may be stored in the memory 703. The instructions 705 may be executable by the processor 701 to implement some or all of the functionality disclosed herein. Executing the instructions 705 may involve the use of the data 707 that is stored in the memory 703. Any of the various examples of modules and components described herein may be implemented, partially or wholly, as instructions 705 stored in memory 703 and executed by the processor 701. Any of the various examples of data described herein may be among the data 707 that is stored in memory 703 and used during execution of the instructions 705 by the processor 701.

A computer system 700 may also include one or more communication interfaces 709 for communicating with other electronic devices. The communication interface(s) 709 may be based on wired communication technology, wireless communication technology, or both. Some examples of communication interfaces 709 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 700 may also include one or more input devices 711 and one or more output devices 713. Some examples of input devices 711 include a keyboard, mouse, microphone, remote control device, button, joystick, trackball, touchpad, and lightpen. Some examples of output devices 713 include a speaker and a printer. One specific type of output device that is typically included in a computer system 700 is a display device 715. Display devices 715 used with embodiments disclosed herein may utilize any suitable image projection technology, such as liquid crystal display (LCD), light-emitting diode (LED), gas plasma, electroluminescence, or the like. A display controller 717 may also be provided, for converting data 707 stored in the memory 703 into text, graphics, and/or moving images (as appropriate) shown on the display device 715.

The various components of the computer system 700 may be coupled together by one or more buses, which may include a power bus, a control signal bus, a status signal bus, a data bus, etc. For the sake of clarity, the various buses are illustrated in FIG. 7 as a bus system 719.

In some implementations, the various components of the computer system 700 are implemented as one device. For example, the various components of the computer system 700 are implemented in a mobile phone or tablet. Another example includes the various components of the computer system 700 implemented in a personal computer.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a clustering model, a regression model, a language model, an object detection model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
obtaining an input graph for a domain based on input data generated from the domain;
identifying a dependency structure from the input graph; and
generating a neural view of a neural graphical model for the domain using the dependency structure.

2. The method of claim 1, wherein the neural graphical model is a probabilistic graphical model with functions that represent complex distributions over the domain.

3. The method of claim 1, wherein the neural view includes an input layer with features of the domain, one or more hidden layers of a neural network, weights, and an output layer with the features.

4. The method of claim 3, further comprising:
training the neural view of the neural graphical model using the input data, wherein functions for features of the domain are learned during the training of the neural view based on paths of the features through the one or more hidden layers of the neural network from the input layer to the output layer and the weights.

5. The method of claim 4, wherein training the neural view of the neural graphical model further comprises:
initializing the weights and parameters of the neural network for the neural view;
optimizing the weights and the parameters of the neural network using a loss function; and
learning the functions using the weights and the parameters of the neural network.

6. The method of claim 5, wherein the loss function fits the neural network to the dependency structure along with fitting a regression of the input data.

7. The method of claim 5, further comprising:
updating the paths of the features through the one or more hidden layers of the neural network from the input to the output based on the functions learned.

8. The method of claim 1, wherein the dependency structure identifies features in the input data that are directly correlated to one another and the features in the input data that are conditionally independent from one another.

9. The method of claim 1, wherein the neural graphical model uses a directed input graph, an undirected input graph, or a mixed-edge input graph.

10. The method of claim 1, further comprising:
providing the neural view of the neural graphical model as output on a display.

11. A method, comprising:
receiving a query for a domain;
accessing a neural view of a neural graphical model of the domain;
using the neural graphical model to perform an inference task to provide an answer to the query; and
outputting a set of values for the neural graphical model based on the inference task for the answer.

12. The method of claim 11, wherein the set of output values is a set of fixed values or a set of distributions over values.

13. The method of claim 11, wherein the inference task predicts unknown values based on the neural graphical model.

14. The method of claim 13, wherein the inference task uses message passing to determine the unknown values in the set of values for the neural graphical model.

15. The method of claim 13, wherein the inference task uses a gradient-based approach to determine the unknown values in the set of values for the neural graphical model.

16. A method, comprising:
accessing a neural view of a neural graphical model of a domain;
using the neural graphical model to perform a sampling task; and
outputting a set of samples generated by the neural graphical model based on the sampling task.

17. The method of claim 16, wherein the sampling task further comprises:
randomly selecting a node in the neural graphical model as a starting node;
placing remaining nodes in the neural graphical model in an order relative to the starting node; and
creating a value for each node of the remaining nodes in the neural graphical model based on values from neighboring nodes to each node of the remaining nodes.

18. The method of claim 17, wherein creating the value for each node further comprises:
adding random noise to the value created for the node based on a distribution conditioned on values from the neighboring nodes.

19. The method of claim 17, wherein the value created for each node is from a same distribution of input data over the domain.

20. The method of claim 16, wherein the neural view includes a trained neural network with an input layer with features from input data, one or more hidden layers of the neural network, optimized weights, an output layer with the features, and functions of the features.
